(19) United States
(12) Patent Application Publication
(10) Pub. No.: US 2014/0337123 A1
(43) Pub. Date: Nov. 13, 2014

(54) SYSTEM AND METHOD FOR ADAPTIVE USE OF GEOFENCE PARAMETERS

(71) Applicant: 30 SECOND SOFTWARE, INC., Austin, TX (US)

(72) Inventors: Peter Nuernberg, AustinS, TX (US); Doug Wick, Austin, TX (US); Eric Newman, Austin, TX (US); David Sikora, Austin, TX (US)

(73) Assignee: 30 SECOND SOFTWARE, INC., Austin, TX (US)

(21) Appl. No.: 14/216,729

(22) Filed: Mar. 17, 2014

Related U.S. Application Data
(60) Provisional application No. 61/798,446, filed on Mar. 15, 2013.

(51) Int. Cl. G06Q 30/02; H04W 4/02

(52) U.S. Cl. CPC G06Q 30/0246; H04W 4/021
USPC 705/14.45

(57) ABSTRACT

A method is provided for ascertaining the proximity of a mobile technology platform to a location. The method includes comparing the percent overlap of a first geofence associated with the mobile technology platform with a second geofence associated with the location; if the percent overlap is greater than a predetermined threshold value T₁, wherein T₁<100%, then marking the mobile technology platform as having entered the second geofence, and otherwise marking the mobile technology platform as not having entered the second geofence.

### CROSS-REFERENCE TO RELATED APPLICATION

This application claims the benefit of U.S. provisional application No. 61/798,446, filed Mar. 15, 2013, having the same title, and the same inventors, and which is incorporated herein by reference in its entirety.

### FIELD OF THE DISCLOSURE

The present disclosure relates generally to mobile communications devices, and more particularly to methods and systems for determining when a mobile communications device has entered and exited a geofence.

### BACKGROUND OF THE DISCLOSURE

Mobile communications device platforms such as the Apple iPhone and the Google Android have several features that make them useful as location detection devices. Location detection is important in mobile applications that require knowledge of whether a user is entering or exiting defined geographic areas known as geofences. For example, in location-based marketing, it is desirable for merchants to know when the user of a mobile device is in the proximity (e.g., within 1000 meters) of a retail store. In such a case, the merchant may wish, for example, to send the user a message with a coupon inviting them to come into the store.

Several methodologies have been developed in the art to determine the location of a mobile communications device at a given point in time. For example, the location of a device may be determined through triangulation of the cell towers the device is communicating with and the properties of the connection the device has with each of these towers. Since mobile communications devices are constantly in communication with nearby cell towers anyway, this approach involves little incremental energy usage by the device. Unfortunately, this method often yields inaccurate results, since the density of cell towers is often insufficiently large to provide meter-level resolution of the location of a device.

Wi-Fi triangulation may also be utilized to determine the location of a mobile communications device. This approach is analogous to cell tower triangulation, but uses Wi-Fi hot spots near the device to determine its position. Wi-Fi triangulation is used, for example, in the location system developed by Skyhook Wireless (Boston, Mass.). Unfortunately, the applicability of this technique is limited, since the set of known Wi-Fi hot spots is relatively small.

The Global Positioning System (GPS) may also be used to determine the location of a mobile communications device. GPS is a constellation of satellites that broadcast location data. This data allows a mobile communications device to determine its location through a triangulation calculation. Unfortunately, GPS signals are weak, and it is typically battery intensive for a mobile communications device to receive and process GPS location updates on an ongoing basis.

Regardless of the methodology used to determine the location of a mobile communications device at a given point in time, the problem exists of how to detect when the device has entered or exited a geofence. Typically, this is accomplished by requiring the device to periodically report its location to a server. The business logic resident in the server then determines whether the most recent location update is of interest. This technique is used, for example, by the commercial services GOOGLE LATITUDE® (www.google.com/latitude) and (www.xtify.com).

The technique of periodically reporting the current location of a mobile communications device to a server is problematic for several reasons. First of all, it raises privacy concerns, because the technique effectively builds a trail of the location of the device over time. Moreover, periodic reporting is also inefficient since, in order for the server to react to the event of a device crossing a geofence in a timely manner, the device must have a high location reporting rate. However, a high reporting rate consumes energy for both the detection and the submission steps of the process.

In addition, periodic reporting suffers from accuracy issues. In particular, since the energy profile of GPS is poor, periodic reporting schemes such as those employed in GOOGLE LATITUDE® do not use GPS for location detection. Consequently, the accuracy of the detected locations is reduced.

### BRIEF DESCRIPTION OF THE DRAWINGS

FIG. 1 is an illustration of a particular, non-limiting embodiment of a system which may be utilized to implement the methodologies described herein.

FIG. 2 is a flow chart of a particular, non-limiting embodiment of a method in accordance with the teachings herein.

FIG. 3 is an illustration of a particular, non-limiting embodiment of a system for managing a marketing campaign over one or more geofences in accordance with the teachings herein.

### SUMMARY OF THE DISCLOSURE

In one aspect, a method is provided for ascertaining the proximity of a mobile technology platform to a location. The method comprises (a) comparing the percent overlap of a first geofence associated with the mobile technology platform with a second geofence associated with the location; (b) if the percent overlap grows to greater than a predetermined threshold value T₁, wherein T₁<100%, then marking the mobile technology platform as having entered the second geofence, and otherwise marking the mobile technology platform as not having entered the second geofence. Conversely, if it falls to below a given (possibly different) threshold value T₂, then marking the mobile technology platform as having exited the second geofence.

In another aspect, a method is provided whereby, given (a) a set of devices, each of which has an associated location estimate consisting of an area (shape) and probability that the device is within this shape; (b) a set of intents; (c) a set of events; and (d) a set of locations, each of which has an associated shape and a mapping of intents to threshold probabilities; a probability may be derived that a given device is at a given location (the center of gravity of the estimate device location area lies within the location area); and, for any given location/intent pair, it may be determined if this probability meets or exceeds the threshold associated with this pair. That is:

### Given:

D={dᵢ}=(dsᵢ,daᵢ),Q={qₖ},E={eᵣ},L={lⱼ=(lsⱼ,tⱼ⊂{Q×[0 . . . 1]})};

Then:

∀dᵢ,lⱼ∃pᵢⱼε[0 . . . 1]; 1)

∀pᵢⱼ,qₖ∃f:{[0 . . . 1]×Q}→{true,false}s.t. f(pᵢⱼ,qₖ)=true iff pᵢⱼ≧tⱼ(eᵣ,qₖ). 2)

As an example, consider a device with a location estimate of being within a circle centered at a latitude/longitude pair (30° 16′0″N, 94° 44′0″W) of radius 30 m with 100% certainty and a location with a circular shape centered at latitude/longitude (30° 16′0′N, 94° 44′0″W) of radius 1000 m. It may be calculated that it is 100% certain that the given device is within the given location.

As another example, consider that it has been calculated that a given device is 50% likely within a given location, and consider a set of intents of {“send a welcome message” and “send an exit survey”} and a set of actions {“enter”, “exit”}. Let “enter” be defined as meaning that a device moved from being at a location with 0 probability to some higher probability; conversely, let “exit” be defined to mean a device moved from being at a location with some non-zero probability to 0 probability. Finally, consider that the location maps (“send a welcome message”, “enter”) to 25% and (“send an exit survey”, “exit” to 75%. If the aforementioned device (that is 50% likely to be in the example location) has just entered this, it may be determined that the threshold has been met to send a welcome message to the device. Conversely, if the device then promptly exits this location, it may be determined that the threshold has not been met to send an exit survey.

In a further aspect, a method is provided for ascertaining the proximity of a mobile technology platform to a location. The method comprises (a) comparing the percent overlap of a first geofence associated with the mobile technology platform with a second geofence associated with the location; (b) if the percent overlap is greater than a predetermined threshold value Tₕ wherein T₁<100%, then sending a first message to the mobile technology platform; and (c) if the percent overlap is greater than a predetermined threshold value T₂, wherein T₁<T₂<100%, then sending a second message to the mobile technology platform, the content of which is distinct from the content of the first message.

In still another aspect, a method is provided for targeting advertisement to a mobile communications device. The method comprises (a) targeting a plurality of mobile technology platforms with an advertising campaign, thereby creating plurality of targeted mobile technology platforms; (b) determining whether a mobile technology platform has entered a location by ascertaining whether a geofence associated with the mobile technology platform has overlapped a geofence associated with the location by a percentage in excess of T; and (c) determining whether any mobile technology platform that has entered the location is a targeted mobile technology platform.

In a further aspect, a method is provided for correlating interest in a product with a visit to a vendor location. The method comprises (a) identifying a party from their login to a web site; (b) ascertaining the interest of the party in a product by identifying the product as being selected for placement into an online shopping cart; (c) determining whether a mobile technology platform associated with the party has entered the vendor location by ascertaining whether a geofence associated with the mobile technology platform has overlapped a geofence associated with the vendor location by a percentage in excess of T; and (d) correlating the party's interest with the product with the party's entry to the vendor location.

In still another aspect, a method is provided for assessing the marketing efficacy of an advertisement. The method comprises (a) identifying a plurality of mobile technology platforms whose geofences have overlapped, by a percentage in excess of T, a geofence associated with a first location at which an advertisement for a product or service is displayed; and (b) determining the percentage of the plurality of mobile technology platforms which (i) are involved in a subsequent purchase of the advertised product or service, or (ii) enter a geofence associated with a second location at which the advertised product or service is sold.

### DETAILED DESCRIPTION

It will be appreciated from the foregoing that there is a need in the art for a means for detecting when a mobile communications device crosses a geofence. There is further a need in the art for such a means that is private, efficient, accurate, and not battery intensive when implemented on a mobile communications device. These and other needs may be addressed by the systems and methodologies disclosed herein.

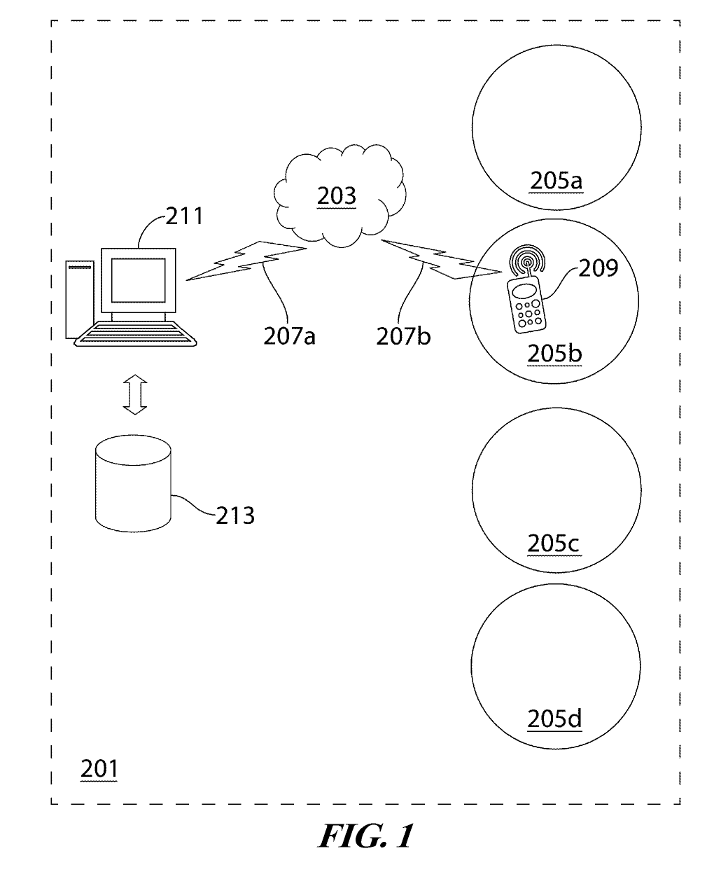

FIG. 1 illustrates one particular, non-limiting embodiment of a system which may be utilized to implement the methodologies described herein. As seen therein, the system 201 preferably comprises a network 203 equipped with a set of geofences 205. The geofences 205 consist of a set of areas 205a-d which are defined by geographic boundaries. Such boundaries may be defined, for example, in terms of latitude, longitude, and radius. Irregular areas may be supported in the systems and methodologies described herein as well.

Suitable network connections 207 are provided to allow a mobile communications device 209 to access a server 211 over the network 203. The server 211 maintains a list of the geofences 205 on the network 203 in an associated database 213, and the mobile communications device 209 is equipped with software, described in greater detail below, which allows the device to periodically query the server 211 for the set of geofences 205 which are proximal to location of the mobile communications device 209 at a given point in time.

The mobile communications device 209 in this particular embodiment has the ability to detect and report its location and accuracy using cell tower or Wi-Fi triangulation, and also has the ability to detect and report its location and accuracy using GPS. The mobile communications device 209 in this particular embodiment further has the ability to run a process in the background that can be triggered by the operating system of the device upon certain predefined events or conditions, and further has the ability to notify the background process when certain predefined location events have occurred. The server 211 in this particular embodiment has the ability to receive geofence entry and exit events from the mobile communications device, and is adapted to react accordingly.

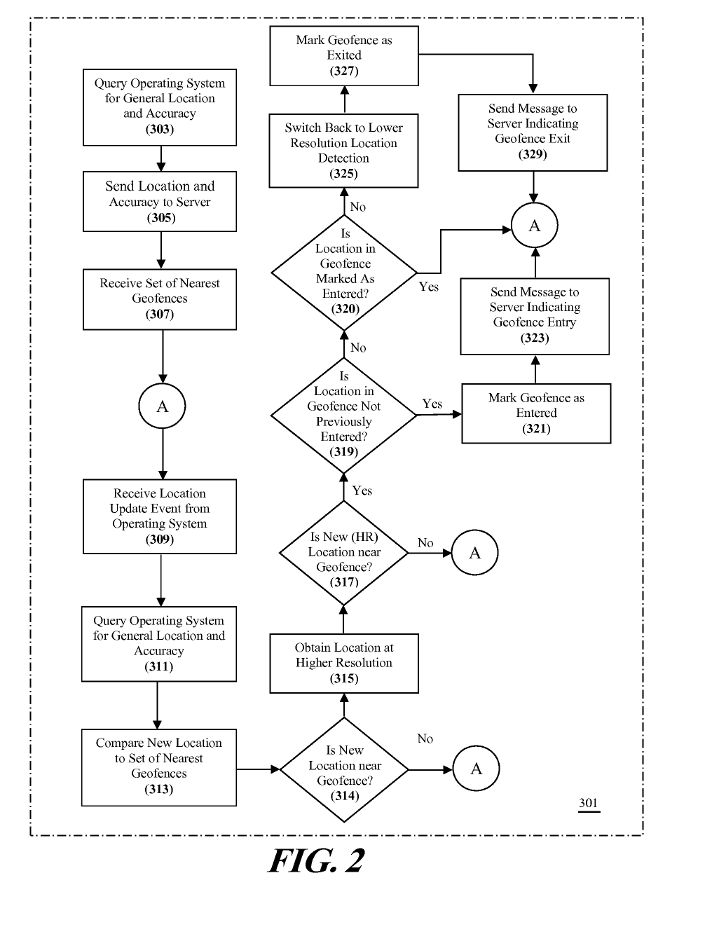

FIG. 2 illustrates a particular, non-limiting embodiment of the methodology disclosed herein. As seen therein, in the particular embodiment 301 depicted, when a mobile communications device first installs the location detection application, the application queries the operating system 303 for the general location of the host device (this location is preferably determined by a lower resolution method such as cell tower or Wi-Fi hot spot triangulation) and the corresponding location accuracy.

The mobile device then sends the location and accuracy 305 data to the server, and requests the set of geofences proximal to it. The server responds with the requested set of proximal geofences 307. Preferably, the server accomplishes this by comparing the center of each geofence in the network to the location of the mobile communications device, and by including in the response a listing of all geofences for which the distance between the geofence and the mobile communications device is less than a predetermined minimum value.

The location detection application subscribes to location changes from the operating system of the mobile communications device. The operating system will then call the location detection application when the location of the mobile communications device has changed by a significant amount. The definition of “significant” for the purposes of this determination is preferably left up to the operating system, and may vary according to a number of factors, including but not limited to: current distance from a monitored geofence; current speed and heading; current accuracy of geolocating the mobile communication device; and/or, history of previous interactions with nearby geofences.

Upon receiving a location update event 309 from the operating system of the mobile communications device, the location detection application retrieves from the operating system of the device the current location of the device and the accuracy associated with determining that location 311. The current location is again preferably determined by a lower resolution method, such as cell tower or Wi-Fi hot spot triangulation.

The location detection application then compares the new location of the device to the set of geofences 313. If the new location of the device is within a predefined distance of the nearest geofence 314, the location detection application switches to higher resolution location detection method, such as GPS location detection, and determines the location of the device with higher resolution 315. If the new location of the device thus determined is not within a predefined distance of the nearest geofence, then the process returns to POINT A.

Upon receiving a higher resolution location update 315, the location detection application compares the new location of the device to the set of geofences to determine if the new location is near a geofence 317. If it is determined that the new location is no longer within a predefined distance of the nearest geofence, the location detection application switches back to the lower resolution location detection mode, and returns the process to POINT A where the process awaits the next location update event 309.

If it is determined that the new location determined by the higher resolution update is within a geofence that was not previously entered 319, the device has entered a geo-zone. The location detection application marks the geofence as entered 321, and sends a message to the server indicating the geofence entry 323. The process then returns to POINT A. If it is determined that the new location determined by the higher resolution update is within a geofence that was previously entered 319, then it is determined whether the location is in a geofence marked as entered 320.

If it is determined whether the location is in a geofence marked as entered 320, the process returns to POINT A. However, if it is determined that the location is not within a geofence that is marked as entered 320, this means that the device has exited a geofence. The device then switches back to lower resolution location detection 325, and the location detection application marks the geofence as exited 327 and sends a message to the server indicating geofence exit 329. The process then returns to POINT A where periodically, or after traveling more than a predetermined distance from the location of the last request for the set of geofences proximal to the mobile communications device, the device will contact the server and request a refreshed set of nearby geofences.

The systems and methodologies disclosed herein are especially useful in implementing methodologies and algorithms that benefit from the knowledge of where users of mobile communications devices are with respect to one or more geofences. One example of such an implementation is an advertising or promotional campaign, wherein a marketer, promoter or other such entity may use the systems and methodologies described herein to identify potential members of a target audience. For example, the owner of a bricks- and mortar retail establishment may wish to know when a consumer has come within a certain proximity to one of their stores. This knowledge may be used, for example, to expose the consumer to advertisements or to offer the consumer coupons, notices of special sales, or other incentives to entice them to enter the establishment.

Preferably, the foregoing objective is accomplished through the use of software which works in conjunction with the systems and methodologies disclosed herein to detect changes (with respect to one or more geofences) in the locations of mobile communications devices owned by consumers. The software preferably includes a software client, an instance of which may be installed on each of a plurality of mobile communications devices. The software client preferably communicates with one or more servers which may be utilized to implement a campaign. The software also preferably includes graphical user interfaces (GUIs) on the server side and/or on the client side, and these GUIs may be the same or different. The server side, the GUI may provide various functionalities to allow marketers, promoters or other users or entities to control or manipulate the system, especially for the purpose of planning, launching, managing or terminating a campaign.

For example, the GUI may provide the ability to adjust campaign throttling so that marketers have more control over how often a certain message is delivered. Thus, the GUI may allow an advertising or marketing campaign manager to set a specific message which is to be delivered to a mobile communications device upon entry and/or exit of a geofence. The message may be set to be delivered at any desired interval. For example, the message may be delivered only once, or it may be delivered periodically (e.g., every X hours). If the message is set to be delivered periodically, the interval may be set to default to a particular value (e.g., once every 12 hours).

The GUI is also preferably equipped with advanced location filtering capabilities. This feature may be useful, for example, for companies having many (e.g., hundreds or thousands) of geofences, where filtering may be vital to being able to readily identify sets of locations that have aspects in common for selection in a campaign. For example, the GUI may be equipped with advanced logical rules on tags and fields to allow users to obtain the exact set of locations that they want.

The GUI may also be equipped with functionalities which enable a user to operate on geo-locations in bulk. For example, the GUI may be equipped with functionalities that permits the user to upload information in bulk for the purpose of establishing or setting up new geofences, or for updating information about existing geofences (such as, for example, adding or removing tags or Wi-Fi information associated with geofences).

The GUI may also be equipped with a map view to allow a user to visualize location-based strategies on a map. This functionality preferably provides the user with the ability to move and resize geofences in the map view, thus facilitating the planning and execution of location-based strategies.

The GUI is also preferably equipped with the ability to send messages to a specific location, while referencing the location in the message itself. This may be accomplished, for example, by adding a variable into an advertising campaign at its creation so that the campaign will automatically insert the location name, address, city, state, zip code, or other identifying features of the geofence to which they were delivered.

The systems and methodologies described herein may utilize appropriate triggers for a campaign, especially those involving the delivery of marketing content to a mobile communications device associated with a consumer. Frequently, the trigger will be an event, such as the interaction between the consumer and a physical location, which may be deduced from the relative location of a geofence and a mobile communications device associated with the consumer. Examples of triggers may include the consumer entering or exiting a location, or the consumer scanning a bar code with, or entering a promotional code into, the client device.

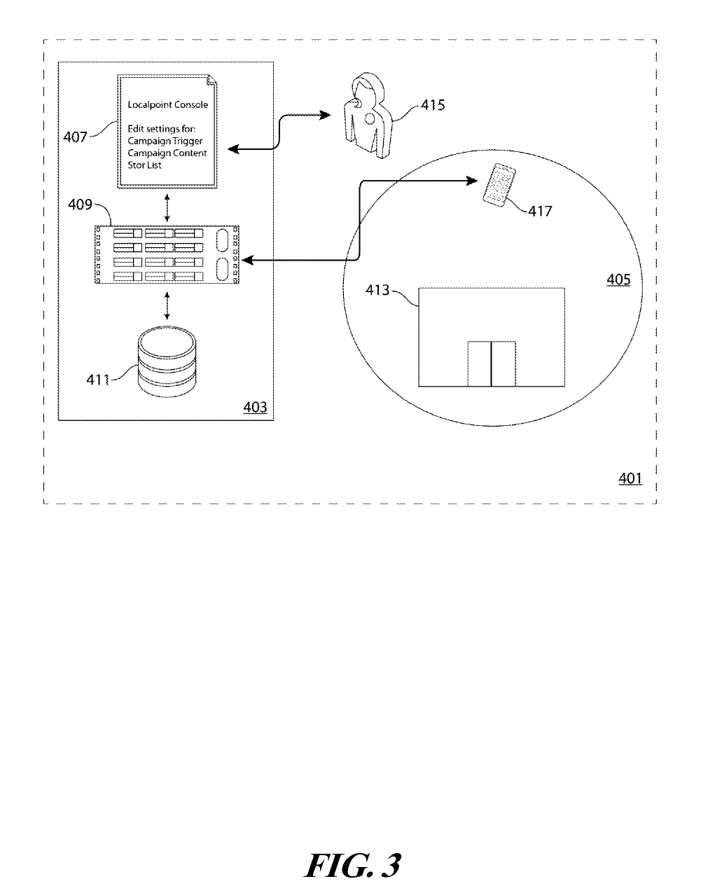

FIG. 3 illustrates a particular, non-limiting embodiment of a system and methodology for the use of triggers in an advertising campaign in accordance with the teachings herein. As seen therein, the system 401 includes a campaign control system 403 which operates in conjunction with one or more geofences 405 (for simplicity of illustration, only a single geofence is depicted) to implement a marketing campaign. The campaign control system 403 includes at least one console 407, one or more application servers 409 and one or more databases 411. Each geofence 405 defines a region, which may consist of a location (such as, for example, a bricks-and-mortar store 413) and a radius.

In a typical implementation of this embodiment, the campaign is managed by a campaign manager 415 who utilizes the console 407 to edit settings pertinent to the campaign. These settings may define, for example, the relevant triggers, a list of participating stores or locations, and the messages, offers, coupons and other campaign content.

Once the parameters of the campaign are established, the application servers 309 communicate as necessary with one or more mobile communications devices 417 to implement the campaign. This may involve, for example, tracking the location of each mobile communications device 417 with respect to one or more geofences 405 and storing or updating this information as necessary in the associated database 411. Each mobile communications devices 417 preferably has a software client installed thereon to facilitate this process.

Various parameters may be defined for a particular campaign. These parameters may include, for example, campaign start dates and times which define, respectively, the dates and times at which campaign materials may be sent to client devices. Similarly, these parameters may include campaign end dates and times which define, respectively, the dates and times at which campaign materials will no longer be sent to client devices. These parameters may also include promotion expiration dates, which mark the last date on which the promotion will be accepted at participating locations (preferably, the promotion expiration date for a campaign will be on or after the campaign end date).

Each campaign defined in the system may also have a status associated with it, which indicates where the campaign is in its life cycle. In a preferred embodiment, the status has a value selected from the group consisting of “scheduled”, “active”, “completed” or “stopped”.

A campaign with the status “scheduled” refers to a campaign which has been entered in the console, but has a start date in the future. Preferably, such a campaign may be edited any time before the start date, and possibly after the start date.

A campaign with the status “active” refers to a campaign which is currently running. While such campaigns may be edited in some embodiments, preferably, promotions which have already been delivered to a mobile communications device will not be updated to reflect such edits unless the client on the mobile communications device refreshes the information received from the server.

A campaign with the status “completed” refers to a campaign whose end date has passed. Any promotions which are associated with the campaign may remain active (depending on their expiration date), but no additional promotions will be sent to client devices. Preferably, completed campaigns cannot be edited in the system.

A campaign with the status “stopped” refers to a campaign which did not reach its end date, but which was stopped in the console. Stopped campaigns preferably do not send any additional promotions associated with the campaign to client devices, although it is preferred that any promotions already sent are not removed from the client device. It is also preferred that stopped campaigns can be edited and restarted.

The systems and methodologies described herein may have the ability to generate various reports. These reports may be designed to allow a campaign manager to measure the success of a campaign, either while it is active or after it has been completed or stopped. Preferably, the console gathers data from the client application for these reports. Such data may include, for example, campaign activity (across locations), check-ins by location (across campaigns), location ranking by level of activity, the number of announcements delivered to client devices (these may be sorted, for example, by campaign and/or location), and the number of announcements opened on client devices (these may be sorted, for example, by campaign and/or location).

Various campaign types may be defined in the systems and methodologies described herein. For example, the campaign may be of a check-in type. This type of campaign is triggered when the user of a mobile communications device selects a check-in option when they have entered a location. The client application on the user's device sends the check-in to the server, which looks for active check-in campaigns for that location. The server then sends the promotional content from the active campaign to the mobile communications device.

The campaign may also be of a geofence exit type. This type of campaign will be triggered when a mobile communications device leaves a geo-location. The trigger causes the software client on the mobile communications device to send the exit event to the server. The server then looks for an active geofence exit campaign for that location and sends a message from the active campaign to the client device.

The campaign may also be of an announcement type. This type of campaign sends scheduled announcements or promotions to client devices which are in a participating location when the announcement is sent.

Various event types may also be defined in the systems and methodologies described herein. These include, without limitation, geofence entry events and message impression events. A geofence entry event is recorded when a mobile communications device with the software client installed thereon enters the geofence of a location defined in the console. A message impression event is recorded when a software client resident on a mobile communications device detects the opening of a notification, announcement, message, or associated promotion (the message may be opened multiple times).

The campaign console described herein may be supported by a variety of browsers. By way of example, the campaign console may be implemented over the Windows Internet Explorer web browser.

Preferably, the systems and methodologies described herein utilize a client application, each instance of which runs on a mobile communications device. The client application may be downloaded to the host device from a suitable source, such as the Apple App Store or the Android Market. The client application preferably communicates with the application server and campaign console to determine when the host device is near a location (i.e., geofence) of interest, and sends any appropriate data to (and receives any appropriate content from) the application server.

The systems and methodologies disclosed herein may utilize various means to ascertain the location of a mobile communications device with respect to a geofence. For example, if a geofence has a Mac Address (BSSID) or an SSID (Wi-Fi ID) associated with it, this information may be entered into the location profile associated with the geofence. The software client resident on a mobile communications device may then use this information to determine the proximity of the host device to the geofence. The use of BSSID is especially preferred, since it is a unique identifier for each location. By contrast, there may be several identical SSIDs in the same general area, though the client software will typically be able to use network positioning to determine the proximity of the host device to a geofence of interest.

The systems and methodologies disclosed herein preferably provide a campaign manager with the ability to define the parameters of a geofence. In a preferred embodiment, each geofence is a location in combination with a radius. This radius, which may be set by the campaign manager, is preferably about 100 m, but may be smaller or larger. For example, the radius of the geofence may be 500 m, 1000 m, or even as high as 5000 m.

The locations used to define the geofences may also be set by the campaign manager. Preferably, these locations are specified as a full or partial address which is entered into the database by way of the console. Such addresses may be entered singularly, or as a batch. The console preferably validates any entered addresses by comparing them to addresses defined in a suitable database, such as the Google address database, and maintains a running error log to notify the campaign manager of any errors in any addresses entered. If the address is ambiguous, the campaign manager may be prompted to select the correct address from a listing of possible addresses.

The systems and methodologies disclosed herein permit the use of geofences as a trigger in new and useful ways. For example, prior applications have typically required a geofence associated with a consumer to be within a geofence of interest for a trigger to occur which results in some action. However, some of the systems and methodologies disclosed herein allow for triggers to be used that may be based on partial overlap of geofences, no overlap (e.g., just touching), or even just the proximity of two geofences. For example, triggers based on partial overlap may be based on overlaps which exceed a given percentage, such as 50%.

The foregoing systems and methodologies are advantageous in that some consumer geofences may be sufficiently large such that the probability of the consumer geofence being inside of a merchant geofence may be small. Consequently, if the trigger is based on the consumer geofence being totally inside the merchant geofence, it is founded on an event that is unlikely to happen. By contrast, use of a partial overlap trigger may allow the consumer's entry into a location to be correctly ascertained, without triggering an unacceptable number of false alarms.

The systems and methodologies disclosed herein may also allow the size of a geofence to be adjusted. In some embodiments, such adjustments may be made by a merchant, a consumer, or both.

In some embodiments of the systems and methodologies disclosed herein, the geofence associated with a consumer or merchant may be manually or programmably adjusted. Such adjustments may depend, for example, on the situation, or on marketing preferences.

In some embodiments, the geofences associated with a merchant or consumer may be a variable in a marketing campaign. For example, in situations involving sending a message welcoming a consumer to a store, it would be embarrassing to the merchant (as well as bad marketing) to send the message to a consumer who is not actually in the merchant's store. Hence, sending such a message might be associated with a high overlap between the consumer geofence and the merchant geofence, to ensure, with a high probability, that the consumer is actually in the store. Other applications, such as a large geofence around a neighborhood, may call for a more liberal approach (e.g., low overlap), since a person proximal to, but not actually in, the neighborhood may nonetheless be a proper target for the message.

In some embodiments of the systems and methodologies disclosed herein, it may be desirable to have geo-based systems with more than one level of defined sensitivity. For example, a merchant may wish to extend an invitation to passersby to come into its store, and may use a lower sensitivity for that purpose. However, the merchant may also wish to make special offers to a consumer after the consumer has entered the store, and may use a higher sensitivity for that purpose.

It will be appreciated that, in the systems and methodologies disclosed herein, the accuracy of a determined overlap of a consumer geofence with a merchant geofence may depend, in part, on the accuracy with which a mobile technology platform can determine its current location. Various statistical algorithms may be utilized to take such uncertainties into account in ascertaining the degree of overlap of two or more geofences.

It will also be appreciated that, in the systems and methodologies disclosed herein, Wi-Fi triangulation may be utilized in conjunction with, or in lieu of, geofence overlap for some applications. For example, in some cases, Wi-Fi triangulation may be utilized to determine the location of a consumer within a store, or to send a message to the consumer while the consumer is in the store. Such an approach may provide the merchant with greater granularity in their marketing campaign.

In some embodiments of the systems and methodologies disclosed herein, geofences may be utilized to implement target location concepts, so that target geofences may be correlated to outreach geofences. For example, if a merchant sends an email to a party inviting the party to visit the merchant's store, the party may open and click through the invitation. In such a situation, a geofence may be utilized to determine whether the party actually visited the store, thus allowing the merchant to assess conversion percentage (to store traffic) across a marketing campaign. It will be appreciated that such information provides important feedback about the efficacy of the marketing campaign.

As a further example of the foregoing, a neighborhood could erect a geofence with a call to action for people within that geofence to visit another location that is correlated to that community. Via the correlation, the conversion rate of targeted people who view the message and then visit the targeted location within a certain period of time may be tracked (e.g., by device ID). In particular, the knowledge of a person viewing an advertisement (however that knowledge is obtained, e.g., by tracking twitter feeds, etc.) could be correlated with their subsequent visit to a targeted location within a certain period of time, thus inferring a positive response. Such traffic may also be correlated to media consumption, with knowledge of media consumption being tied with a geofence trigger (e.g., a party that consumed the media showed up somewhere). In some applications, a login at a site may be utilized (possibly in conjunction with abandoned shopping cart items) to identify interest in an item, and subsequent entry into a geofence may be utilized by a marketer to connect those dots.

As yet another example of the foregoing, a correlation may be established between viewing a billboard with a subsequent purchase or entry into geofence. Viewing of the billboard may be evidenced, for example, by a tracking feature showing that a person passed within a certain proximity of billboard, which may make use, for example, of a geofence established around the billboard.

Various statistical algorithms may be utilized in establishing the foregoing correlations or in correlating media consumption, or other consumer activities, with subsequent entry into a geofence (or purchase of an item or service) for the purposes described herein. For example, the population correlation coefficient ρ_{X,Y} between two random variables X and Y with expected values μ_{X} and μ_{Y} and standard deviations σ_{X} and σ_{Y} may be defined by EQUATION 1:

$$\begin{matrix}{ρ}_{X , Y} = corr ( X , Y ) \\ = \frac{cov ( X , Y )}{{σ}_{x} {σ}_{y}} \\ = \frac{E [ ( X - {μ}_{x} ) ( Y - {μ}_{y } ) ]}{{σ}_{x} {σ}_{y}}\end{matrix} \qquad ( EQUATION 1 )$$

where E is the expected value operator, coy means covariance, and corn is a widely used alternative notation for Pearson's correlation. The Pearson correlation is defined only if both of the standard deviations are finite and both of them are nonzero, and the correlation cannot exceed 1 in absolute value. The correlation coefficient is also symmetric, that is, corr(X,Y)=corr(Y,X).

The Pearson correlation is +1 in the case of a perfect positive (increasing) linear relationship (correlation), −1 in the case of a perfect decreasing (negative) linear relationship (anticorrelation), and some value between −1 and 1 in all other cases, indicating the degree of linear dependence between the variables. As it approaches zero, there is less of a relationship (closer to uncorrelated). The closer the coefficient is to either −1 or 1, the stronger the correlation between the variables. If the variables are independent, Pearson's correlation coefficient is 0 (however, the converse is not true, because the correlation coefficient detects only linear dependencies between two variables).

In some of the embodiments of the systems and methodologies disclosed herein, there may be a series of n measurements of X and Y written as xᵢ and yᵢ where i=1, 2, . . . , n. In such cases, the sample correlation coefficient may be used to estimate the population Pearson correlation r between X and Y. The sample correlation coefficient may be written as EQUATION 2:

$$\begin{matrix}{r}_{xy} = \frac{{\sum }_{i = 1}^{n} ( {x}_{i} - \overline{x} ) ( {y}_{i} - \overline{y} )}{( n - 1 ) {s}_{x} {s}_{y}} \\ = \frac{{\sum }_{i = 1}^{n} ( {x}_{i} - \overline{x} ) ( {y}_{i } - \overline{y} )}{\sqrt{{\sum }_{i = 1}^{n} {( {x}_{i} - \overline{x} )}^{2} {\sum }_{i = 1}^{n} {( {y}_{i} - \overline{y} )}^{2}}}\end{matrix} \qquad ( EQUATION 2 )$$

where x and y are the sample means of X and Y, and sₓ, and s_{y} are the sample standard deviations of X and Y. EQUATION 2 can also be written as:

$$\begin{matrix}{r}_{xy} = \frac{\sum {x}_{i} {y}_{i} - n \overline{x} \overline{y}}{( n - 1 ) {s}_{x} {s}_{y}} \\ = \frac{n \sum {x}_{i} {y}_{i } - \sum {x}_{i} \sum {y}_{i}}{\sqrt{n \sum {x}_{i}^{2} - {( \sum {x}_{i} )}^{2}} \sqrt{n \sum {y}_{i}^{2} - {( \sum {y}_{i} )}^{2}}}\end{matrix} \qquad ( EQUATION 3 )$$

In some embodiments of the systems and methodologies disclosed herein, the fact that people visited store or merchant location at a particular time may be utilized to target them with media at a later time (this is a form of retargeting). As a specific example, the knowledge that a consumer visited a store, or series of stores, may be used to change the digital signage that the consumer sees the next time they enter a store.

In some embodiments of the systems and methodologies disclosed herein, a visit to a physical store or location may be correlated to a cookie. The concept behind this approach is to record places the consumer has visited, and to use the cumulative nature of those visits to target a message or advertisement. As a specific example, a consumer's visit to two Texas A&M games (that is, games in which A&M was the common competitor) may be used to infer that the consumer would be interested in Texas A&M apparel. It will thus be appreciate that this approach may be utilized to resolve ambiguities (e.g., the consumer's likely sports affiliation). Hence, these systems and methodologies may be utilized, for example, to provide physical world retargeting, with more visits decreasing ambiguity.

In some embodiments of the systems and methodologies disclosed herein, raw location data feed may be obtained from a mobile technology platform. Such feed may include, for example, the latitude and longitude of the device, and its speed and the direction it is moving (the foregoing may be obtained, for example, from an accelerometer resident on the device, and may be subjected to adaptive or interpretive algorithms). In these embodiments, the use of moving averages or medians may be utilized to provide a different (and in some cases, more accurate) view of the data. For example, since the first reading related to the geo-location of a device may be subject to a higher degree of error or uncertainty, the first reading (or a certain top and bottom percent of the acquired data) may be discarded, so that the raw feed is processed in a different way.

The foregoing approach may be used, for example, to discern the intent of the owner of the device by using an algorithm to interpret raw feed. For example, this approach may be utilized to determine whether the device owner intends to come to a vendor location, or actually visited that location. By way of specific example, if the device owner was near a vendor location for a certain period of time, and there was nothing else around, it is likely that the device owner actually visited the location, even if that event cannot be explicitly confirmed due to uncertainties in ascertaining the degree of geofence overlap (due, for example, to limitations in available geospatial resolution). In some cases, this conclusion may be verified (or cast into doubt) by searching for neighboring geofences, or ascertaining the lack thereof, to further determine the intent of the device owner by identifying possible alternative explanations.

In some embodiments of the systems and methodologies disclosed herein, the future or past trajectory of a mobile technology platform may be inferred from data feeds, and these inferred trajectories may be further utilized to identify geofence entry, even if the geofence entry went undetected. In such embodiments, the size of geofence may be modified or tuned to, for example, capture more data by capturing a larger number of near-misses. In some embodiments, this functionality may be adaptive to circumstances and may be controlled in real time, thus allowing for auto-sizing of geofences.

It will be appreciated that some embodiments of the systems and methodologies disclosed herein allow for separation of the definition of location and the definition of a geofence (which may act as the trigger on a mobile technology platform). Thus, for example, rather than asking a merchant to determine the size of a geofence associated with a merchant's location, a geofence may be established around the location, and a service provider may determine how large to make the geofence trigger on the mobile technology platform. Suitable software or hardware algorithms may then be utilized to calculate, and possibly continually refine, the geofence. Such refinements may be based, for example, on probable traffic patterns and tower locations (this latter factor determines the accuracy with which the location of a mobile technology platform can be determined, and hence is a factor in determining the optimum size of the geofence). Thus, for example, the trigger may be made tighter in locations where there is greater accuracy associated with determining the geospatial location of a mobile technology platform.

In various embodiments of the systems and methodologies disclosed herein, various methods may be utilized to determine the location of a device or to infer intent. For example, location may be determined by calculating the area of a consumer geofence which is inside target geofence, and this overlap may be expressed as a percentage, a ratio, or in another suitable format. As a different approach, in some embodiments, the size of the geofence per se may be optimized.

In some embodiments of the systems and methodologies disclosed herein, a system interface or client may be installed on a mobile technology platform to implement tracking, geofence modification, or other features, functionalities or algorithms disclosed herein, and the architecture of the interface or client may be constructed so that it is operating system agnostic. For example, such an architecture may feature a core system display architecture (SDA) with a shim layer or connector to each of a plurality of different operating systems, and a native application programming interface (API) layer. Algorithms or functionalities pertaining, for example, to the device's geofence may then be put inside a common core. Consequently, when modifications are made to the operating system of the host device, it is only necessary to rewrite or modify the connector, not the core algorithms.

From a software perspective, the locative and geospatial functionalities and algorithms of the host operating system appear as abstract location providers which operate in some abstract fashion to perform locative functions (that is, they provide the location of the host device in whatever way they do so). Hence, the specifics of these functionalities, such as whether the host operating system can turn on and off Wi-Fi or GPS programmatically, are details that the core algorithms do not need to concern themselves with. Instead, for the purposes of these core algorithms, there are various location detections with various resolutions in the host operating system that consume various amounts of power, and the core algorithms talk to an abstract location provider resident in the connector that determines what to do on each of the various operating systems.

In some embodiments of the systems and methodologies disclosed herein, native software and hardware features on a mobile technology platform may be leveraged to provide a better understanding of various events. By way of example, native accelerometers on mobile technology platforms may be utilized to help a merchant distinguish between foot traffic and automotive traffic in the interpretation of raw data. Hence, rather than working merely with the location of points, these features may provide a context for a clearer understanding of the captured data.

In some embodiments of the systems and methodologies disclosed herein, collected data may undergo a transformation from anonymous to non-anonymous as the collected data is correlated with other information about the user of a mobile technology platform. For example, the user's profile may be inferred from location history (that is, where the user went), and may be tied to demographics. As more location data is accumulated, the accuracy of the user's profile may be enhanced.

This capability may be utilized, for example, to provide merchants with statistical feedback based on user or consumer profiles. This capability may also facilitate customer segmentation based on location analytics such as, for example, segmentation schemes based on location history, or location-based insight (i.e., which stores have the most visits, which have the least, in which ones do people stay longer). It will be appreciated that this capability thus provides the means by which merchant locations may be analyzed using various parameters and performance metrics.

Some embodiments of the systems and methodologies disclosed herein may utilize personas for the provision of useful location analytics. Such personas may be, for example, titular designations that a marketer may give to different categories of consumers they engage with. For example, the designation “Saturday afternoon campers” may be given a category of consumers who visit a store location and stay for 4 hours, while the designation “lunchtime visitors” may be given to a category of consumers that visit a store location during normal lunchtime business hours. Teams within marketers may wish to focus only on the messages they wish to send to, and the products they wish to sell to, a specific persona. Hence, the ability to provide location analytics associated with a specific persona is of significant value to marketers.

Some embodiments of the systems and methodologies disclosed herein may utilize various retargeting principles and algorithms. For example, some such embodiments may utilize information about past activities of consumers (or classes of consumers or personas) and their subsequent conversion on certain advertisements to select an advertisement to present to a present consumer. Hence, the concept is one of collaborative filtering, in which the marketer uses information that the consumer has, for example, undertaken actions X, Y and Z, looks at other consumers who have also undertaken actions X, Y and Z and how they convert on a particular advertisement versus other advertisements, and then uses that information to select an advertisement to be presented to the consumer that will give the best chance of conversion. It will be appreciated that this approach, coupled with location data taken over a period of time, may provide marketers with valuable insights about specific customer segments or personas.

It will also be appreciated that some of the systems and methodologies described herein may be utilized to learn more about customers through geofencing. By way of example, a marketer could learn that a customer is a business traveler through the customer's interaction with geofences at airports. Hence, the locations at which geofencing is applied in the systems and methodologies disclosed herein are not necessarily limited to retail locations.

Geofencing may also be utilized in some of the systems and methodologies disclosed herein to conduct exit reviews. For example, when a consumer leaves a store, a geofence may be utilized by the merchant to identify the fact that the consumer has left the store, and to present the consumer with a timely opportunity to evaluate their experience at the location or provide other useful feedback. For example, such feedback may include a rating of the location by the consumer (e.g., a rating based on 1-5 stars). Hence, geofences may be utilized to trigger the sending of a survey, so that the survey is timely displayed on the mobile technology platform of a person who just exited the location.

Geofencing may also be utilized in some of the systems and methodologies disclosed herein for proximity detection. For example, geofencing may be utilized to alert store personnel to the imminent arrival of the consumer at a store location, and may be utilized to trigger a suitable customer service response upon entering the location.

Geofencing may also be utilized in the systems and methodologies described herein as a proximity detector to reduce variability surrounding the placement of an order. By way of example, if a consumer wishes to make a reservation at a restaurant, traffic variability may effect when the consumer actually arrives at the restaurant. However, geofencing may be utilized to determine when the consumer is within sufficient proximity of the restaurant that such variability become negligible. Hence, when the consumer makes the reservation, the order may staged and then provisioned when the geofence around restaurant is breached, thus indicating that the consumer's arrival at the restaurant is imminent, and the variability surrounding their arrival has been reduced or eliminated.

Some embodiments of the systems and methodologies disclosed herein may also be utilized to tie outdoor locations to indoor locations. For example, some merchant locations have the capability of using multiple Wi-Fi routers to determine a consumer's location in store; hence, this capability may be leveraged to provide some of the same capabilities inside of a store location as are possible outside of that location.

By way of example, the foregoing capability may be leveraged to perform location analytics, target location analysis, and physical world retargeting that extends indoors as well as outdoors. These capabilities may also be leveraged to obtain dwell times for specific locations within a store (e.g., around a cosmetics counter) in much the same way that dwell times can be ascertained for a store in general.

It will also be appreciated that the foregoing approach may increase the granularity of the analysis in some applications. For example, in looking at conversion rates, the granularity of a system based solely on geofencing may be limited to a specific location (e.g., a store). However, the foregoing approach may be utilized to extend this granularity to locations within the store, such as end caps. Consequently, this approach allows marketers to target locations at different levels such as, for example, store, department in store, or end cap, and hence provides greater granularity for indoor locations.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

What is claimed is:

A1. A method for assessing the marketing efficacy of an advertisement, comprising:
identifying a plurality of mobile technology platforms whose geofences have overlapped, by a percentage in excess of T, a geofence associated with a first location at which an advertisement for a product or service is displayed; and
determining the percentage of the plurality of mobile technology platforms which (a) are involved in a subsequent purchase of the advertised product or service, or (b) enter a geofence associated with a second location at which the advertised product or service is sold.

A2. The method of claim A1, wherein the second location is a plurality of locations.

A3. The method of claim A1, further comprising determining the percentage of the plurality of mobile technology platforms which are involved in a subsequent purchase of the advertised product or service within a specified period of time.

A4. The method of claim A1, further comprising determining the percentage of the plurality of mobile technology platforms which enter a geofence associated with a second location at which the advertised product or service is sold within a specified period of time.

B1. A method for ascertaining the proximity of a mobile technology platform to a location, comprising:
comparing the percent overlap of a first geofence associated with the mobile technology platform with a second geofence associated with the location;
if the percent overlap is greater than a predetermined threshold value T₁, wherein T₁<100, then marking the mobile technology platform as having entered the second geofence, and otherwise marking the mobile technology platform as not having entered the second geofence.

B2. The method of claim B1, wherein 0<T₁<100%.

B3. The method of claim B1, wherein the location is a physical store, and wherein T is set by the merchant.

B4. The method of claim B1, wherein T₁ is set by a client resident on the mobile technology platform.

B5. The method of claim B1 wherein, if the mobile technology platform is marked as having entered the geofence, then sending a message to the mobile technology platform.

B6. The method of claim B5, wherein the message is selected from the group consisting of advertisements and offers.

B7. The method of claim B1, wherein T₁ is programmably adjustable.

B8. The method of claim B1, wherein T₁ is manually adjustable.

B9. The method of claim B1, wherein the location is a store, and further comprising:
if the percent overlap is greater than T₁, then determining whether the mobile communications device is associated with a person who was targeted in an advertising campaign.

B10. The method of claim B9, wherein determining whether the mobile communications device is associated with a person who was targeted in an advertising campaign includes determining whether an advertising message associated with the store was sent to the mobile communications device.

B11. The method of claim B9, wherein determining whether the mobile communications device is associated with a person who was targeted in an advertising campaign includes determining whether an advertising message associated with the store was sent to the mobile communications device within the past month.

B12. The method of claim B9, wherein determining whether the mobile communications device is associated with a person who was targeted in an advertising campaign includes determining whether an advertising message associated with the store was sent to the mobile communications device within the past week.

B13. The method of claim B9, wherein determining whether the mobile communications device is associated with a person who was targeted in an advertising campaign includes determining whether an advertising message associated with the store was sent to the mobile communications device within the past three days.

B14. The method of claim B9, wherein determining whether the mobile communications device is associated with a person who was targeted in an advertising campaign is part of an effort to determine conversion rates across an advertising campaign.

C1. A method for ascertaining the proximity of a mobile technology platform to a location, comprising:
comparing the percent overlap of a first geofence associated with the mobile technology platform with a second geofence associated with the location;
if the percent overlap is greater than a predetermined threshold value T₁, wherein T₁<100%, then sending a first message to the mobile technology platform, and if the percent overlap is greater than a predetermined threshold value T₂, wherein T₁<T₂<100%, then sending a second message to the mobile technology platform, the content of which is distinct from the content of the first message.

C2. The method of claim C1, wherein the location is a store, and wherein an overlap in excess of the threshold value T₂ indicates entry into the store.

C3. The method of claim C2, wherein an overlap in excess of the threshold value T₁ indicates proximity to the store.

C4. The method of claim C1, wherein the first and second messages are selected from the group consisting of advertisements and offers.

D1. A method for targeting advertisement to a mobile communications device, comprising:
targeting a plurality of mobile technology platforms with an advertising campaign, thereby creating plurality of targeted mobile technology platforms;
determining whether a mobile technology platform has entered a location by ascertaining whether a geofence associated with the mobile technology platform has overlapped a geofence associated with the location by a percentage in excess of T; and
determining whether any mobile technology platform that has entered the location is a targeted mobile technology platform.

D2. The method of claim D1, further comprising:
determining the percentage of targeted mobile technology platforms that have entered the location.

D3. The method of claim D1, wherein determining whether any mobile technology platform that has entered the location is a targeted mobile technology platform includes comparing a device ID to which an advertising message was sent to the device ID of a mobile technology platform that has entered the location.

D4. The method of claim D1, wherein determining whether any mobile technology platform that has entered the location is a targeted mobile technology platform includes comparing a device ID on which certain media was consumed on to the device ID of a mobile technology platform that has entered the location.

D5. The method of claim D1, wherein determining whether any mobile technology platform that has entered the location is a targeted mobile technology platform includes
tracking a media feed;
associating a device ID with consumption of the tracked media feed; and
determining whether an associated device ID corresponds to the device ID of a mobile technology platform that has entered the location.

D6. The method of claim D1, wherein the location is a bricks and mortar store associated with a merchant.

E1. A method for correlating interest in a product with a visit to a vendor location, the method comprising:
identifying a party from their login to a web site;
ascertaining the interest of the party in a product by identifying the product as being selected for placement into an online shopping cart;
determining whether a mobile technology platform associated with the party has entered the vendor location by ascertaining whether a geofence associated with the mobile technology platform has overlapped a geofence associated with the vendor location by a percentage in excess of T; and
correlating the party's interest with the product with the party's entry to the vendor location.

E2. The method of claim E1, wherein the shopping cart is abandoned.

E3. The method of claim E1, further comprising:
confirming purchase of the product by the party at the vendor location.
